(19) United States
(12) Patent Application Publication
(10) Pub. No.: US 2006/0235124 A1
(43) Pub. Date: Oct. 19, 2006

(54) Stabilizer system for the stabilisation of halogenated polymers

(76) Inventors: Wolfgang Wehner, Zwingenberg (DE); Hans-Helmut Friedrich, Lautertal-gadernheim (DE); Karl-Josef Kuhn, Lautertal-Gadernheim (DE); Thomas Hopfmann, Lampertheim (DE)

Correspondence Address: Michael P Dilworth;Crompton Corporation, Benson Road, Middlebury, CT, 06749, US

(21) Appl. No.: 10/555,021

(22) PCT Filed: Apr. 2, 2004
(86) PCT No.: PCT/EP04/03486

§ 371 Date: Oct. 26, 2005

(30) Foreign Application Priority Data
Apr. 26, 2003 (DE) 10318910.6

(51) Int. Cl. C08K 5/36

(52) U.S. Cl. 524/392; 252/397; 524/236

(57) ABSTRACT

The invention relates to a mixture of stabilisers for the stabilisation of chlorinated polymers, comprising at least a) a sulphate ester salt and/or a sulphonate salt of formula (I): [R(O)ₐSO₃]₁M and b) an alkanolamine of formula (II), where M=alkali, earth alkali, lanthanide (Cer) or aluminium cation, t=metal cation valence of 1, 2 or 3; s=0 or 1, R=C₁-C₂₂ a phenyl, C₇-C₁₀ phenylalkyl, C₇ -C₂₄ alkylphenyl, x=1, 2 or 3: y=1, 2, 3, 4, 5 or 6; n=1-10. R¹, R² independently=H. C₁-C₂₂ alkyl, —[—(CHR³ₐ)_{y}—CHR³_{b}—O—]ₐ—H, —[—(CHR³ₐ)_{y}—CHR³_{b}—O-]n-CO—R⁴, C₂-C₂₀ alkenyl, C₂-C₁₈ acyl, C₄-C₈ cycloalkyl, optionally substituted at the B-position by OH, C₆-C₁₀ aryl, C₇-C₁₀ alkaryl or C₇-C₁₀ aralkyl, or when x=1, R¹ and R² together with the N can form a closed 4-10 membered ring of carbon atoms with optionally up to 2 heteroatoms, or when x=2, R¹ also=C₂-C₁₈ alkylene, optionally substituted at both B-carbon atoms with OH and/or interrupted by 1 or more O atoms and/or 1 or more NR² groups, or dihydroxysubstituted tetrahydrodicyclopentadienylene, dihydroxysubstituted ethylcyclohexanylene, dihydroyxsubstituted 4,4′-bisphenol-A-dipropylether)ylene, isophoronylene, dimethylcyclohexanylene, dicyclohoxylmethanylene or 3,3′-dimethyldicyclohexylmethanylene and when x=3, R¹ also=trihydroxysubstituted (tri-N-propylisocyanurate)triyl, R³ₐ, R³_{b} independently=C₁-C₂₂ alkyl, C₂-C₆ alkenyl) C₆-C₁₀ aryl, H or CH₂—X—R⁵, where X═O, S, —O—CO— or —CO—O—; R⁴═C₁-C₁₈ alkyl/alkenyl or phenyl and R⁵═H, C₁-C₂₂ alkyl, C₂-C₂₂ alkenyl or C₆-C₁₀ aryl.

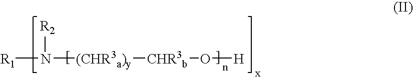

The invention relates to stabilizer mixtures encompassing at least a sulphate ester salt and/or sulphonate salt and an alkanolamine which are suitable for stabilizing halogen-containing polymers.

For example, PVC as halogen-containing polymer may be stabilized by a large number of additives. Compounds of lead, of barium, and of cadmium are particularly well suited to this purpose, but are nowadays controversial for environmental reasons or because of their heavy metal content (cf. “Plastics Additives Handbook” H. Zweifel, Carl Hanser Verlag, 5th Edition 2001, pp. 427-483, and “Kunststoff Handbuch PVC” [Plastics Handbook PVC], Volume 2/1, W. Becker and D. Braun, Carl Hanser Verlag, 2nd Edition, 1985, pp. 531-538; and Kirk-Othmer: “Encyclopedia of Chemical Technology”, 4th Edition, 1994, Vol. 12, Heat Stabilizers, pp. 1071-1091).

There is therefore a continuing search for effective stabilizers and stabilizer mixtures which are free from lead, barium and cadmium.

It has now been found that mixtures made from at least one alkanolamine of the general formula (II), and from at least one sulphate ester salt and/or sulphonate salt of the formula (I), in particular alkali metal or alkaline earth metal salt, are particularly highly suitable for stabilizing chlorine-containing polymers, in particular PVC.

The invention accordingly provides stabilizer mixtures comprising at least

a) one sulphate ester salt and/or sulphonate salt of the formula (I)
[R(O)ₛSO₃]ₜM (I)

b) and one alkanolamine of the formula (II) 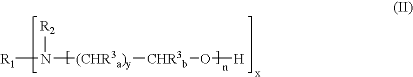
where: M=alkali metal cation, alkaline earth metal cation, lanthanoid (cerium) cation or aluminium cation, t=valency of the metal cation, namely 1, 2 or 3; s=0 or 1 and R═C₁-C₂₂-alkyl, phenyl, C₇-C₁₀-phenylalkyl, C₇-C₂₄-alkylphenyl and
x=1, 2 or 3,
y=1, 2, 3, 4, 5 or 6,
n=1-10
R¹, R²=independently H, C₁-C₂₂-alkyl, —[—(CHR³ₐ)_{y}—CHR³_{b}—O—]ₙ—H, —[—(CHR³ₐ)_{y}—CHR³_{b}—O—]ₙ—CO—R⁴, C₂-C₂₀-alkenyl, C₂-C₁₈-acyl, C₄-C₈-cycloalkyl, which may be OH-substituted in the β position, C₆-C₁₀-aryl, C₇-C₁₀-alkaryl or C₇-C₁₀-aralkyl, or when x=1, R¹ and R² may additionally combine with the N to form a closed 4-10-membered ring of carbon atoms and optionally up to 2 heteroatoms, or when x=2, R¹ may additionally be C₂-C₁₈-alkylene which may be OH-substituted at both β-carbon atoms and/or may be interrupted by one or more O-atoms and/or one or more NR² groups, or dihydroxy-substituted tetrahydrodicyclopenta-dienylene, dihydroxy-substituted ethylcyclohexanylene, dihydroxy-substituted 4,4′-(bisphenol A dipropyl ether)ylene, isophoronylene, dimethylcyclohexanylene, dicyclohexylmethanylene, or 3,3′-dimethyldicyclohexylmethanylene, and if x=3, R¹ may also be trihydroxy-substituted (tri-N-propyl isocyanurate)triyl;
R³ₐ, R³_{b}=independently of one another, C₁-C₂₂-alkyl, C₂-C₆-alkenyl, C₆-C₁₀-aryl, H or CH₂—X—R⁵, where X═O, S, —O—CO— or —CO—O—;
R⁴═C₁-C₁₈-alkyl/alkenyl or phenyl, and
R⁵═H, C₁-C₂₂-alkyl, C₂-C₂₂-alkenyl or C₆-C₁₀-aryl.

The invention further provides stabilizer mixtures comprising at least
a) one sulphate ester salt and/or sulphonate salt of the formula (I)
b) one reaction product made from a mono- or polyfunctional epoxide and from ammonia or from a mono- or polyfunctional dialkyl(aryl)- or monoalkyl(aryl)amine.

Examples of the alkanolamines of the general formula (II) are compounds where R¹ and R²=methyl, ethyl, propyl, butyl, cyclohexyl, octyl, lauryl, tetradecyl, hexadecyl, stearyl, oleyl, allyl, phenyl or benzyl, hydroxyalkyl and R³═H, methyl, ethyl, propyl or butyl. Preference is given to alkanolamines where R¹=lauryl, tetradecyl, hexadecyl, stearyl, oleyl, where R²=hydroxyalkyl. It is also possible to use ethoxylates and propoxylates of triethanol- and triisopropanolamine, or else to use fatty amines of plant or animal origin. Preference is given to trialkanolamines and mono-alkyl/alkenyl-dialkanolamines where R³═H or methyl and y=1, in particular fatty amines that have been reacted twice with ethylene or with propylene oxide. Other compounds which are very highly suitable may be taken from the following list.

Octyl- or dioctylamine reacted once or twice with ethylene oxide or with propylene oxide;

Isooctyl- or diisooctylamine reacted once or twice with ethylene oxide or with propylene oxide;

Nonyl- or dinonylamine reacted once or twice with ethylene oxide or with propylene oxide;

Isononyl- or diisononylamine reacted once or twice with ethylene oxide or with propylene oxide;

Decyl- or didecylamine reacted once or twice with ethylene oxide or with propylene oxide;

Tsodecyl- or diisodecylamine reacted once or twice with ethylene oxide or with propylene oxide;

Undecyl- or diundecylamine reacted once or twice with ethylene oxide or with propylene oxide;

Isoundecyl- or diisoundecylamine reacted once or twice with ethylene oxide or with propylene oxide;

Dodecyl- or didodecylamine reacted once or twice with ethylene oxide or with propylene oxide;

Isododecyl- or diisododecylamine reacted once or twice with ethylene oxide or with propylene oxide;

Tridecyl- or ditridecylamine reacted once or twice with ethylene oxide or with propylene oxide;

Isotridecyl- or diisotridecylamine reacted once or twice with ethylene oxide or with propylene oxide;

Tetradecyl- or ditetradecylamine reacted once or twice with ethylene oxide or with propylene oxide;

Hexadecyl- or dihexadecylamine reacted once or twice with ethylene oxide or with propylene oxide;

Octadecyl- or dioctadecylamine reacted once or twice with ethylene oxide or with propylene oxide;

Eicosyl- or dieicosylamine reacted once or twice with ethylene oxide or with propylene oxide;

Docosyl- or didocosylamine reacted once or twice with ethylene oxide or with propylene oxide;

Octadecenyl- or dioctadecenylamine reacted once or twice with ethylene oxide or with propylene oxide;

Benzyl- or dibenzylamine reacted once or twice with ethylene oxide or with propylene oxide;

Cyclohexyl- or dicyclohexylamine reacted once or twice with ethylene oxide or with propylene oxide;

N-methylcyclohexylamine reacted with ethylene oxide or with propylene oxide;

N-ethylcyclohexylamine reacted with ethylene oxide or with propylene oxide;

4-Vinyl-1-cyclohexene diepoxide reacted twice with diethanol- or diisopropanolamine;

Dicyclopentadiene diepoxide reacted twice with diethanol- or diisopropanolamine;

Bisphenol A diglycidyl ether reacted twice with diethanol- or diisopropanolamine;

Trisglycidyl isocyanurate reacted three times with diethanol- or diisopropanolamine.

Preference is given to trialkanolamines and monoalkyl/alkenyldialkanolamines where R³ₐ, R³_{b}, independently of one another, are H or methyl, and y=1.

It has been determined that compounds of the general formula (I) where y=1-6, i.e. having up to 6 methylene groups between the amino group and the hydroxyl-substituted carbon atom, are useful as PVC stabilizer in combination with a sulphate ester salt and/or sulphonate salt.

According to the invention it is also possible to use compounds of the general formula (II) where x=3, i.e. those which have three hydroxyalklylamino groups per molecule. An example here is the product of a reaction of trisglycidyl isocyanurate with mono- or diethanolamine or mono- or dipropanolamine.

The alkanolamines of the general formula (II) are commercially available chemicals or may be prepared by known methods, by N-alkylating a corresponding amine or ammonia (cf. Alkanolamines in Kirk-Othmer Encyclopedia of Chemical Technology, 4th Edition, J. Wiley & Sons N.Y., 1992, Vol. 2, pages 1-34).

Examples of the preferred alkanolamines of the general formula (II) are tris(2-hydroxyethyl)amine, tris(2-hydroxy-1-propyl)amine, bis(2-hydroxyethyl)-2-hydroxy-1-propylamine, N-n-butyl-N,N-bis(2-hydroxyethyl)amine, N,N-bis(n-butyl)-N-(2-hydroxyethyl)amine, N-(3-n-butyloxy-2-hydroxy-1-propyl)-N,N-bis(2-hydroxyethyl)-amine, N-(1,3-dihydroxy-2-hydroxymethyl-2-propyl)-N,N-bis(2-hydroxyethyl)amine, N,N-bis(2-hydroxyethyl)-N-palmitylamine, N,N-bis(2-hydroxyethyl)-N-oleylamine, N,N-bis(2-hydroxyethyl)-N-soyaamine, N,N-bis(2-hydroxyethyl)-N-stearylamine, N-(2-hydroxyethyl)-morpholine or N-(2,3-dihydroxy-1-propyl)morpholine, bishydroxyethylpiperazine or bishydroxyisopropyl-piperazine and products of the reaction of glycidyl ethers with mono- or dialkylamine or ammonia, and also the alkanolamines derived from these, such as ethanolamine, diethanolamine, n-propanolamine, isopropanolamine, n-dipropanolamine or isodipropanolamine.

Very particular preference is given to addition products of olefin oxides, such as octene oxide, decene oxide, dodecene oxide, tetradecene oxide, hexadecene oxide, octadecene oxide, eicosene oxide, and docosene oxide, and also epoxystearyl alcohol with diethanol- or diisopropanolamine. These compounds having a positioned OH function at both ends of a relatively long alkyl chain, e.g. N-(2-hydroxyhexadecyl)diethanolamine, N-(2-hydroxy-3-octyloxypropyl)diethanolamine, N-(2-hydroxy-3-decyloxypropyl)diethanolamine, N-(2-hydroxy-3-octyloxypropyl)diethanolamine and bis-N-(2-hydroxy-3-phenyloxypropyl)ethanolamine are particularly suitable as a component in the stabilizer systems of the invention.

The list merely gives examples and is not intended to be comprehensive.

The sulphate ester salts and/or sulphonate salts are known to the person skilled in the art (cf. Sulfonation and Sulfation, Sulfonic Acids Sulfuric and Sulfurous esters and surfactants in Kirk-Othmer Encyclopedia of Chemical Technology, 4th Edition, J. Wiley & Sons N.Y., 1992 Vol. 23, pp. 146-193, 194-217, 409-428 and 478-541). Examples are those of the formula [R(O)ₛSO₃]ₜM, where M is Li, Na, K, Mg, Ca, Sr, Ba, Zn, Al, La or Ce.

Use may be made of these sulphate ester salts and/or sulphonate salts in their various commonly encountered forms, e.g. as salt or as solution in water or in an organic solvent or absorbed on a support, such as PVC, Ca silicate, zeolites or hydrotalcites. Other examples of such formulations are sulphate ester salts and/or sulphonate salts complexed or dissolved using alcohols (polyols, cyclodextrins) or using ether alcohols or ester alcohols or crown ether.

The sulphate ester salts and/or sulphonate salts preferably used are those of sodium and/or of potassium. Preference is given to salts of the monomethyl, -ethyl, -propyl, -butyl, -hexyl, -octyl, -isooctyl, -decyl, -lauryl, -hexadecyl and -octadecyl ester of sulphuric acid and/or to salts of methane-, ethane-, benzene-, toluene- and C₈-C₁₄-alkylbenzene-sulphonic acid.

The invention also provides combinations of the stabilizer mixtures according to the invention with at least one other conventional additive or stabilizer. The invention therefore includes combinations of the stabilizer mixtures encompassing at least one sulphate ester salt and/or sulphonate salt of the general formula (I) and at least one compound of the general formula (II) with at least one other conventional additive or stabilizer. Preference is given to phosphites, polyols and disaccharide alcohols, glycidyl compounds, hydrotalcites, zeolites (alkali metal aluminosilicates and alkaline earth metal aluminosilicates), fillers, metal soaps, alkali metal and alkaline earth metal compounds, lubricants, plasticizers, pigments, epoxidized fatty esters and other epoxy compounds, antioxidants, UV absorbers, light stabilizers, optical brighteners and blowing agents.

Particular preference is given to epoxidized fatty acid esters and other epoxy compounds, polyols, alkaline earth metal soaps, zeolites, hydrotalcites and phosphites. Very particular preference is given to phosphites and phosphites in combination with polyols, and also to anhydrous hydrotalcites and zeolites. The possible reaction of products of the components used are also encompassed.

Preference is also given to stabilizer mixtures which additionally comprise an aminouracil, enamine, an indole, or a urea. Examples of suitable compounds are 1,3-dimethyl-4-aminouracil, 1,4-butanediol bis(β-aminocrotonate), thiodiethylene glycol bis(β-aminocrotonate), 2-phenylindole, 2-phenyllaurylindole, N,N′-diphenylthiourea. Other examples are described in the applicant's German patent application 101 07 329.

Examples of additional components of this type are listed and explained at a later stage below (cf. “Handbook of PVC Formulating” by E. J. Wickson, John Wiley & Sons, New York 1993).

Polxyrols and Disaccharide Alcohols

Examples of possible compounds of this type are: pentaerythritol, dipentaerythritol, tripentaerythritol, trimethylolethane, bis(trimethylolpropane), polyvinyl alcohol, bis(trimethylolethane), trimethylolpropane, sugars, sugar alcohols. Of these, preference is given to the disaccharide alcohols.

It is also possible to use polyol syrups, such as sorbitol syrup, mannitol syrup and maltitol syrup. Examples of the amounts of the polyols used are from 0.01 to 20 parts by weight, advantageously from 0.1 to 20 parts by weight and in particular from 0.1 to 10 parts by weight, based on 100 parts by weight of PVC.

Glycidyl Compounds

These contain the glycidyl group 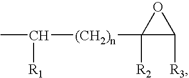
bonded directly to carbon, oxygen, nitrogen or sulphur atoms, either where both of R₁ and R₃ are hydrogen, R₂ is hydrogen or methyl and n=0 or where R₁ and R₃ together are —CH₂—CH₂— or —CH₂—CH₂—CH₂—, R₂ then being hydrogen and n being 0 or 1.

It is preferable to use glycidyl compounds having two functional groups. However, it is also possible in principle to use glycidyl compounds having one, three or more functional groups.

Use is predominantly made of diglycidyl compounds having aromatic groups.

The amounts used of the terminal epoxy compounds are preferably at least 0.1 part, preferably from 0.1 to 50 parts by weight, advantageously from 1 to 30 parts by weight and in particular from 1 to 25 parts, based on 100 parts by weight of PVC.

Hydrotalcites

The chemical composition of these compounds is known to the skilled worker, e.g. from the patents DE 3 843 581, U.S. Pat. No. 4,000,100, EP 0 062 813 and WO 93/20135.

Compounds from the hydrotalcite series may be described by the following general formula
M²⁺₁₋ₓM³⁺ₓ(OH)₂(A^{b-})_{x/b}.d H₂O,
where

M²⁺=one or more of the metals selected from the group consisting of Mg, Ca, Sr, Zn and Sn

M³⁺=Al or B,

Aⁿ an anion of valency n,

b is a number from 1-2,

0<x<0.5,

d is a number from 0-20.

Preference is given to compounds with

Aⁿ=OH⁻, ClO₄⁻, HCO₃⁻, CH₃COO⁻, C₆H₅COO⁻, CO₃²⁻, (CHOHCOO)₂²⁻, (CH₂COO)₂²⁻, CH₃CHOHCOO⁻, HPO₃⁻ or HPO₄³⁻;

Examples of hydrotalcites are Al₂O₃.6MgO—CO₂.12H₂O (i), Mg_{4.5}Al₂(OH)₁₃.CO₃.3.5H₂O (ii), 4MgO.Al₂O₃.CO₂.9H₂O (iii), 4MgO.Al₂O₃.CO₂.6H₂O, ZnO.3MgO.Al₂O₃.CO₂.8-9H₂O and ZnO.3MgO.Al₂O₃.CO₂.5-6H₂O. Very particular preference is given to the following types: Alkamizer 2, Alkamizer P 93-2 (from Kyowa) and L-CAM (lithium-modified hydrotalcite, from Fuji). Anhydrous hydrotalcites are preferably used.

Zeolites (Aluminosilicates of Alkali Metals and/or of Alkaline Earth Metals)

These may be described by the following general formula

M_{x/n}[(AlO₂)(SiO₂)_{y}].wH₂O, where n is the charge on the cation M; p M is an element of the first or second main group, such as Li, Na, K, Mg, Ca, Sr or Ba;

y:x is a number from 0.8 to 15, preferably from 0.8 to 1.2; and

w is a number from 0 to 300, preferably from 0.5 to 30.

Examples of zeolites are sodium aluminosilicates of the formulae

Na₁₂Al₁₂Si₂O₄₈.27 H₂O [zeolite A] , Na₆Al₆Si₆O₂₄.2 NaX.7.5 H₂O, X═OH, halogen, ClO₄ [sodalite]; Na₆Al₆Si₃₀O₇₂.24 H₂O; Na₈Al₈Si₄₀O₉₆.24 H₂O; Na₁₆Al₁₆Si₂₄O₈₀.16 H₂O; Na₁₆Al₁₆Si₃₂O₉₆.16 H₂O; Na₅₆Al₅₆Si₁₃₆O₃₈₄.250 H₂O [zeolite Y], Na₈₆Al₈₆Si₁₀₆O₃₈₄.264 H₂O [zeolite X];

or the zeolites which can be prepared by partial or complete exchange of the Na atoms by Li atoms, K atoms, Mg atoms, Ca atoms, Sr atoms or Zn atoms, for example (Na, K)₁₀Al₁₀Si₂₂O₆₄.20 H₂O; Ca_{4.5}Na₃[(AlO₂)₁₂(SiO₂)₁₂].30 H₂O; K₉Na₃[(AlO₂)₁₂(SiO₂)₁₂].27 H₂O.

Very particular preference is given to Na zeolite A and Na zeolite P.

The hydrotalcites and/or zeolites may be used in amounts of, for example, 0.1 to 20 parts by weight, expediently 0.1 to 10 parts by weight and in particular 0.1 to 5 parts by weight, based on 100 parts by weight of halogen-containing polymer.

Fillers

Fillers such as calcium carbonate, dolomite, wollastonite, magnesium oxide, magnesium hydroxide, silicates, china clay, talc, glass fibres, glass beads, wood flour, mica, metal oxides or metal hydroxides, carbon black, graphite, rock flour, heavy spar, glass fibres, talc, kaolin and chalk are used. Preference is given to chalk (HANDBOOK OF PVC FORMULATING E. J. Wickson, John Wiley & Sons, Inc., 1993, pp. 393-449) and reinforcing agents (TASCHENBUCH der Kunststoffadditive [Plastics Additives Handbook], R. Gächter & H. Müller, Carl Hanser, 1990, pp. 549-615).

The fillers may be used in amounts of preferably at least one part by weight, for example 5 to 200 parts by weight, expediently 5 to 150 parts by weight and in particular from 5 to 100 parts by weight, based on 100 parts by weight of PVC.

Metal Soaps

Metal soaps are primarily metal carboxylates, preferably of relatively long-chain carboxylic acids. Well-known examples of these are stearates and laurates, and also oleates and salts of relatively short-chain aliphatic or aromatic carboxylic acids, such as acetic acid, propionic acid, butyric acid, valeric acid, hexanoic acid, sorbic acid; oxalic acid, malonic acid, succinic acid, glutaric acid, adipic acid, fumaric acid, citric acid, benzoic acid, salicylic acid, phthalic acids, hemimellitic acid, trimellitic acid, pyromellitic acid. Metals which should be mentioned are: Li, Na, K, Mg, Ca, Sr, Ba, Zn, Al, La, Ce and rare earth metals. Use is frequently made of so-called synergistic mixtures, such as barium/zinc stabilizers, magnesium/zinc stabilizers, calcium/zinc stabilizers or calcium/magnesium/zinc stabilizers. The metal soaps may be used either alone or in mixtures. An overview of common metal soaps is found in Ullmann's Encyclopedia of Industrial Chemistry, 5th Ed., Vol. A16 (1985), pp. 361 et seq.

The metal soaps or a mixture of these may be used in amounts of, for example, 0.001 to 10 parts by weight, expediently 0.01 to 8 parts by weight, particularly preferably 0.05 to 5 parts by weight, based on 100 parts by weight of PVC.

Alkali Metal and Alkaline Earth Metal Compounds

For the purposes of the present invention, these are mainly the carboxylates of the acids described above, but also corresponding oxides or, respectively, hydroxides or carbonates. Mixtures of these with organic acids are also possible. Examples are LiOH, NaOH, KOH, CaO, Ca(OH)₂, MgO, Mg(OH)₂, Sr(OH)₂, Al(OH)₃, CaCO₃ and MgCO₃ (and also basic carbonates, such as magnesia alba and huntite), and also fatty-acid salts of Na and of K. In the case of alkaline earth carboxylates and Zn carboxylates it is also possible to or Zn), so-called “overbased” compounds. In addition to the stabilizers according to the invention it is preferable to use alkali metal carboxylates, alkaline earth metal carboxylates and/or aluminium carboxylates.

Lubricants

Examples of possible lubricants are: montan wax, fatty acid esters, PE waxes, amide waxes, chloroparaffins, glycerol esters and alkaline earth metal soaps, and fatty ketones, and also the lubricants, or combinations of the lubricants, listed in EP 0, 259 783. Calcium stearate is preferred.

Plasticizers

Examples of organic plasticizers are those from the following groups:

A) Phthalates: such as preferably di-2-ethylhexyl, diisononyl and diisodecyl phthalate, also known by the common abbreviations DOP (dioctyl phthalate, di-2-ethylhexyl phthalate), DINP (diisononyl phthalate), DIDP (diisodecyl phthalate).

B) Esters of aliphatic dicarboxylic acids, in particular esters of adipic, azelaic or sebacic acid: preferably di-2-ethylhexyl adipate and diisooctyl adipate.

C) Trimellitic esters, such as tri-2-ethylhexyl trimellitate, triisodecyl trimellitate (mixture), trimellitate (mixture), and also tri-C₆-C₈-alkyl, tri-C₆-C₁₀-alkyl, tri-C₇-C₉-alkyl and tri-C₉-C₁₁-alkyl trimellitate. Common abbreviations are TOTM (trioctyl trimellitate, tri-2-ethylhexyl trimellitate), TIDTM (triisodecyl trimellitate) and TITDTM (triisotridecyl trimellitate).

D) Epoxy plasticizers: these are primarily epoxidized unsaturated fatty acids, e.g. epoxidized soybean oil.

E) Polymeric plasticizers: the commonest starting materials for preparing polyester plasticizers are: dicarboxylic acids, such as adipic, phthalic, azelaic or sebacic acid; diols, such as 1,2-propanediol, 1,3-butanediol, 1,4-butanediol, 1,6-hexanediol, neopentyl glycol and diethylene glycol.

F) Phosphoric esters: a definition of these esters is given in the abovementioned “Taschenbuch der Kunststoffadditive” [“Plastics Additives Handbook”], Chapter 5.9.5, pp. 408-412. Examples of these phosphoric esters are tributyl phosphate, tri-2-ethylbutyl phosphate, tri-2-ethylhexyl phosphate, trichloroethyl phosphate, 2-ethylhexyl diphenyl phosphate, cresyl diphenyl phosphate, triphenyl phosphate, tricresyl phosphate and trixylenyl phosphate. Preference is given to 2-triethylhexyl phosphate and Reofos® 50 and Reofos® 95 from Ciba Spezialitatenchemie.

G) Chlorinated hydrocarbons (paraffins)

H) Hydrocarbons

I) Monoesters, e.g. butyl oleate, phenoxyethyl oleate, tetrahydrofurfuryl oleate and alkylsulphonates.

J) Glycol esters, e.g. diglycol benzoates.

A definition of these plasticizers and examples for the same are given in “Kunststoffadditive” [“Plastics Additives”], R. Gächter/H. Müller, Carl Hanser Verlag, 3rd Ed., 1989, Chapter 5.9.6, pp. 412-415, and in “PVC Technology”, V. Titow, 4th Ed., Elsevier Publ., 1984, pp. 165-170. It is also possible to use mixtures of different plasticizers.

The plasticizers may be used in amounts of, for example, 5 to 20 parts by weight, expediently 10 to 20 parts by weight, based on 100 parts by weight of PVC. Rigid or semirigid PVC comprises preferably up to 10%, particularly preferably up to 5%, of plasticizer, or no plasticizer.

Pigments

Suitable substances are known to the skilled worker. Examples of inorganic pigments are TiO₂, pigments based on zirconium oxide, BaSO₄, zinc oxide (zinc white) and lithopones (zinc sulphide/barium sulphate), carbon black, carbon black-titanium dioxide mixtures, iron oxide pigments, Sb₂O₃, (Ti,Ba,Sb)O₂, Cr₂O₃, spinels, such as cobalt blue and cobalt green, Cd(S,Se), ultramarine blue. Examples of organic pigments are azo pigments, phthalocyanine pigments, quinacridone pigments, perylene pigments, diketopyrrolopyrrole pigments and anthraquinone pigments. TiO₂ in micronized form is also preferred. A definition and further descriptions-are found in the “Handbook of PVC Formulating”, E. J. Wickson, John Wiley & Sons, New York, 1993.

Phosphites

Organic phosphites are known costabilizers for chlorine-containing polymers. Examples of these are trioctyl, tridecyl, tridodecyl, tritridecyl, tripentadecyl, trioleyl, tristearyl, triphenyl, trilauryl, tricresyl, tris(nonylphenyl), tris(2,4-tert-butylphenyl) and tricyclohexyl phosphite. Other suitable phosphites are various mixed aryl dialkyl or alkyl diarylphosphites, such as phenyl dioctyl, phenyl didecyl, phenyl didodecyl, phenyl ditridecyl, phenyl ditetradecyl, phenyl dipentadecyl, octyl diphenyl, decyl diphenyl, undecyl diphenyl, dodecyl diphenyl, tridecyl diphenyl, tetradecyl diphenyl, pentadecyl diphenyl, oleyl diphenyl, stearyl diphenyl and dodecyl bis(2,4-di-tert-butylphenyl)phosphite.

Advantageous use may also be made of phosphites of various di- or polyols: e.g. tetraphenyldipropylene glycol diphosphite, polydipropylene glycol phenyl phosphite, tetraisodecyl dipropylene glycol diphosphite, tris(dipropylene glycol) phosphite, tetramethylolcyclohexanol decyl diphosphite, tetramethylolcyclohexanol butoxyethoxyethyl diphosphite, tetramethylolcyclohexanol nonylphenyl diphosphite, bis(nonylphenyl)di(trimethylolpropane)diphosphite, bis(2-butoxyethyl)di(trimethylolpropane)diphosphite, tris(hydroxyethyl)isocyanurate hexadecyl triphosphite, didecyl pentaerythrityl diphosphite, distearyl pentaerythrityl diphosphite, bis(2,4-di-tert-butylphenyl)pentaerythrityl diphosphite, and also mixtures of these phosphites and aryl/alkyl phosphite mixtures of empirical composition (H₁₉C₉—C₆H₄O)_{1.5}P(OC_{12,13}H_{25,27})_{1.5} or [C₈H₁₇—C₆H₄—O—]₂P[i-C₈H₁₇O], (H₁₉C₉—C₆H₄O)_{1.5}P (OC_{9,11}H_{19,23})_{1.5}.

Example amounts of the organic phosphites used are from 0.01 to 10, advantageously from 0.05 to 5 and in particular from 0.1 to 3 parts by weight, based on 100 parts by weight of PVC.

Epoxidized Fatty Acid Esters and Other Epoxy Compounds

The stabilizer combination of the invention may additionally and preferably comprise at least one epoxidized fatty acid ester. Possible compounds here are especially esters of fatty acids from natural sources (fatty acid glycerides), such as soya oil or rapeseed oil. However, it is also possible to use synthetic products, such as epoxidized butyl oleate. Use may also be made of epoxidized polybutadiene and polyisoprene, if desired also in a partially hydroxylated form, or of glycidyl acrylate and glycidyl methacrylate as homo- or copolymer. These epoxy compounds may also have been applied to an alumino salt compound; in this connection see also DE-A-4 031 818.

Antioxidants

Alkylated monophenols, e.g. 2,6-di-tert-butyl-4-methyl-phenol, alkylthiomethylphenols, e.g. 2,4-dioctyl-thiomethyl-6-tert-butylphenol, alkylated hydroquinones, e.g. 2,6-di-tert-butyl-4-methoxyphenol, hydroxylated thiodiphenyl ethers, e.g. 2,2′-thiobis(6-tert-butyl-4-methylphenol), alkylidenebisphenols, e.g. 2,2′-methylenebis(6-tert-butyl-4-methylphenol), benzyl compounds, e.g. 3,5,3′,5′-tetratert-butyl-4,4′-dihydroxydibenzyl ether, hydroxybenzylated malonates, e.g. dioctadecyl 2,2-bis(3,5-di-tert-butyl-2-hydroxybenzyl)malonate, hydroxybenzyl aromatics, e.g. 1,3,5-tris(3,5-di-tert-butyl-4-hydroxybenzyl)-2,4,6-trimethylbenzene, triazine compounds, e.g. 2,4-bisoctylmercapto-6-(3,5-di-tert-butyl-4-hydroxyanilino)-1,3,5-triazine, phosphonates and phosphonites, e.g. dimethyl 2,5-di-tert-butyl-4-hydroxybenzylphosphonate, acylaminophenols, e.g. 4-hydroxylauranilide, esters of beta-(3,5-ditert-butyl-4-hydroxyphenyl)propionic acid, beta-(5-tert-butyl-4-hydroxy-3-methylphenyl)propionic acid, beta-(3,5-dicyclohexyl-4-hydroxyphenyl)propionic acid, esters of 3,5-ditert-butyl-4-hydroxyphenylacetic acid with mono- or polyhydric alcohols, amides of beta-(3,5-ditert-butyl-4-hydroxyphenyl)propionic acid, such as, for example, N,N′-bis(3,5-ditert-butyl-4-hydroxyphenyl-propionyl)hexamethylenediamine, vitamin E (toccpherol) and derivatives.

Examples of the amounts of the antioxidants used are from 0.01 to 10 parts by weight, advantageously from 0.1 to 10 parts by weight and in particular from 0.1 to 5 parts by weight, based on 100 parts by weight of PVC.

UV Absorbers and Light Stabilizers

Examples of these are: 2-(2′-hydroxyphenyl)benzotriazoles, such as 2-(2′-hydroxy-5′-methylphenyl)-benzotriazole, 2-hydroxybenzophenones, esters of unsubstituted or substituted benzoic acids, such as 4-tert-butylphenyl salicylate, phenyl salicylate, acrylates, nickel compounds, oxalamides, such as 4,4′-dioctyloxyoxanilide, 2,2′-dioctyloxy-5,5′-ditert-butyloxanilide, 2-(2-hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, sterically hindered amines, such as bis(2,2,6,6-tetramethylpiperidin-4-yl)sebacate, bis(2,2,6,6-tetramethylpiperidin-4-yl)succinate.

Blowing Agents

Examples of blowing agents are organic azo compounds and organic hydrazo compounds, tetrazoles, oxazines, isatoic anhydride, and also soda and sodium bicarbonate. Preference is given to azodicarbonamide and sodium bicarbonate and also mixtures of these.

Definitions for and examples of impact modifiers and processing aids, gelling agents, antistats, biocides, metal deactivators, optical brighteners, flame retardants, antifogging agents and compatibilizers are given in “Kunststoffadditive” [“Plastics Additives”], R. Gächter/H. Müller, Carl Hanser Verlag, 3rd Ed., 1989, and 4th Edition, 2001, and in “Handbook of Polyvinyl Chloride Formulating” E. J. Wilson, J. Wiley & Sons, 1993, and also in “Plastics Additives” G. Pritchard, Chapman & Hall, London, 1st edition, 1998. Impact modifiers are also described in detail in “Impact Modifiers for PVC”, J. T. Lutz/D. L. Dunkelberger, John Wiley & Sons, 1992.

The invention also provides compositions which comprise a chlorine-containing polymer and a stablizer mixture of the invention.

The amounts of the compounds of the general formula (II) present for stabilization in these chlorine-containing polymer compositions are advantageously from 0.01 to 10 parts by weight, preferably from 0.05 to 5 parts by weight, based on 100 parts by weight of PVC.

Examples of the amount used of the sulphate ester salts and/or sulphonate salts are from 0.001 to 10 parts by weight, advantageously from 0.01 to 5 parts by weight, particularly preferably from 0.01 to 3 parts by weight, based on 100 parts by weight of PVC.

Preference is given to compositions in which the ratio of the compound of the general formula (II) to the sulphate ester salt and/or sulphonate salt, based on weight, is in the range of from 1.5:1 to 10:1.

Examples of the chlorine-containing polymers to be stabilized are: polymers of vinyl chloride, of vinylidene chloride, vinyl resins whose structure contains vinyl chloride units, such as copolymers of vinyl chloride and vinyl esters of aliphatic acids, in particular vinyl acetate, copolymers of vinyl chloride with esters of acrylic or methacrylic acid and with acrylonitrile, copolymers of vinyl chloride with diene compounds and with unsaturated dicarboxylic acids or anhydrides of these, such as copolymers of vinyl chloride with diethyl maleate, diethyl fumarate or maleic anhydride, postchlorinated polymers and copolymers of vinyl chloride, copolymers of vinyl chloride and vinylidene chloride with unsaturated aldehydes, ketones and others, such as acrolein, crotonaldehyde, vinyl methyl ketone, vinyl methyl ether, vinyl isobutyl ether and the like; polymers of vinylidene chloride and copolymers of the same with vinyl chloride and with other polymerizable compounds; polymers of vinyl chloroacetate and of dichlorodivinyl ether; chlorinated polymers of vinyl acetate, chlorinated polymeric esters of acrylic acid and of alpha-substituted acrylic acid; polymers of chlorinated styrenes, such as dichlorostyrene; chlorinated rubbers; chlorinated polymers of ethylene; polymers and postchlorinated polymers of chlorobutadiene and copolymers of these with vinyl chloride, chlorinated natural or synthetic rubbers, and also mixtures of the polymers mentioned with themselves or with other polymerizable compounds. For the purposes of this invention, PVC includes copolymers with polymerizable compounds, such as acrylonitrile, vinyl acetate or ABS, where these may be suspension polymers, bulk polymers or else emulsion polymers.

Preference is given to a PVC homopolymer, also in combination with polyacrylates.

Other possible polymers are graft polymers of PVC with EVA, ABS or MBS. Other preferred substrates are mixtures of the abovementioned homo- and copolymers, in particular vinyl chloride homopolymers, with other thermoplastic or/and elastomeric polymers, in particular blends with ABS, MBS, NBR, SAN, EVA, CPE, MBAS, PMA, PMMA, EPDM or with polylactones, in particular from the group consisting of ABS, NBR, NAR, SAN and EVA. The abbreviations used for the copolymers are familiar to the skilled worker and have the following meanings: ABS: acrylonitrile-butadiene-styrene; SAN: styrene-acrylonitrile; NBR: acrylonitrile-butadiene; NAR: acrylonitrile-acrylate; EVA: ethylene-vinyl acetate. Other possible polymers are in particular styrene-acrylonitrile copolymers based on acrylate (ASA).

A preferred component in this context is a polymer composition which comprises, as components (i) and (ii), a mixture of 25-75% by weight of PVC and 75-25% by weight of the copolymers itteniioned. Components of particular importance are compositions made from (i) 100 parts by weight of PVC and (ii) 0-300 parts by weight of ABS and/or SAN-modified ABS and 0-80 parts by weight of the copolymers NBR, NAR and/or EVA, but in particular EVA.

For the purposes of the present invention it is also possible to stabilize in particular recycled materials of chlorine-containing polymers, specifically the polymers described in more detail above, which have been degraded by processing, use or storage. Recycled material from PVC is particularly preferred.

The compounds which may be used concomitantly according to the invention, and also the chlorine-containing polymers, are well known to the skilled worker and are described in detail in “Kunststoffadditive” [“Plastics Additives”], R. Gächter/H. Müller, Carl Hanser Verlag, 3rd Ed., 1989; in DE 197 41 778 and in EP-A 0 967 245, which are incorporated herein by way of reference.

The inventive stabilization is suitable for chlorine-containing polymer compositions that are non-plasticized or plasticizer-free or substantially plasticizer-free compositions, and also as for plasticized compositions.

The compositions of the invention are useful in particular, in the form of rigid formulations, for hollow articles (bottles), packaging films (thermoformable films), blown films, crash pad films (cars), tubes, foams, heavy profiles (window frames), translucent-wall profiles, building profiles, films (including Luvitherm films), PVC tubes, profiles, sidings, fittings, office films and equipment housings (computers and domestic appliances).

Preferred other compositions, in the form of flexible formulations, are for wire sheathing, cable insulation, decoration sheeting, roofing films, foams, agricultural sheeting, hoses, sealing profiles, floorcoverings, motor vehicle parts, flexible films, injection mouldings, office films and films for air halls. Examples of the use of the compositions according to the invention as plastisols are synthetic leather, floorings, textile coatings, wallcoverings, coil coatings and underfloor sealing for motor vehicles. Examples of sintered PVC applications of the compositions according to the invention are slush, slush mould and coil coatings and also in E-PVC for Luvitherm films.

The stabilizers may advantageously be incorporated by the following methods: as emulsion or dispersion (one possibility is, for example, the form of a pasty mixture, an advantage of the combination of the invention in the case of this administration form is the stability of the paste); as a dry mixture during the mixing of added components or polymer mixtures; by direct addition into the processing apparatus (e.g. calender, mixer, kneader, extruder or the like) or as a solution or melt or, respectively, as flakes or pellets in a dust-free form as one-pack.

The PVC stabilized according to the invention, which is also provided by the invention, may be prepared in a manner known per se, by using equipment known per se, such as the abovementioned processing apparatus, to mix the stabilizer mixture of the invention and, if desired, other additives, with the PVC. The stabilizers here may be added individually or in a mixture, or else in the form of what are known as masterbatches. The PVC stabilized as in the present invention may be brought into the desired shape in a known manner. Examples of processes of this type are grinding, calendering, extruding, injection moulding and stabilized PVC may also be processed to give foams. The invention therefore also provides a process for stabilizing chlorine-containing polymers by adding of the stabilizer mixture according to the invention to a chlorine-containing polymer, and also provides products comprising PVC stabilized by the stabilizer mixture according to the invention.

A PVC stabilized according to the invention is, for example, particularly suitable for hollow articles (bottles), packaging films (thermoformed films), blown films, pipes, foams, heavy profiles (window frames), translucent-wall profiles, construction profiles, films (including Luvitherm films), PVC tubes, profiles, sidings, fittings, office sheeting and apparatus housings (computers, household devices).

The PVC of the invention is suitable particularly for semirigid and flexible formulations, especially in the form of flexible formulations for wire sheathing, cable insulation, floorcoverings, wallcoverings, motor vehicle parts, flexible films, injection mouldings or hoses which are particularly preferred. In the form of semirigid formulations the PVC of the invention is particularly suitable for decorative films, foams, agricultural films, hoses, sealing profiles and office films.

Examples of the use of the PVC according to the invention as plastisol are synthetic leather, floor coverings, textile coatings, wall coverings, coil coatings and underfloor sealing for motor vehicles. Examples Of wintered PVC applications of the PVC stabilized according to the invention are slush, slush mould and coil coatings for plastisol, semirigid and flexible formulations.

For more detail in this connection see “Kunststoffhandbuch PVC” [“Plastics Handbook PVC”], Vol. 2/2, W. Becker/H. Braun, 2nd Ed., 1985, Carl Hanser Verlag, pp. 1236-1277.

The examples below illustrate the invention but do not restrict the same. As in the remainder of the description, parts and percentages given are based on weight.

TABLE 1
Stabilizers (I)

| Stabilizer | Formula |
|---|---|
| 1 | CH₃—O—SO₃Na (50% strength in H₂O) |
| 2 | 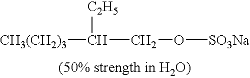 |
| 3 | CH₃ (CH₂)₁₁O—SO₃Na |
| 4 | CH₃ (CH₂)₁₁SO₃Na |
| 5 | 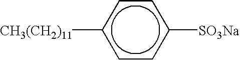 |
| 6 | 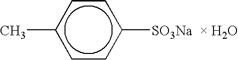 |

### EXAMPLE 1

### Static Heat Test

A mixture composed of
100.0 parts of Evipol (trademark of EVC) SH 7020-PVC K value 70
47.0 parts of dioctyl phthalate
3.0 parts of ESO=epoxidized soya bean oil
0.3 part of Loxiol® G 71 S=pentaerythritol adipate complex ester-lubricant
0.1 part of calcium stearate
x parts of a stabilizer given in Table 1

and 0.6 part of triethanolamine (TEA) were rolled for 5 minutes at 180° C. on mixing rolls. Test strips of film, thickness 0.5 mm, were removed from the milled sheet formed. The film specimens were exposed to heat at 190° C. in an oven (=Mathis Thermo-Takter). The Yellowness Index (YI) was determined at 3 minute intervals to ASTM D1925-70. The results are reported in Table 2. Where appropriate, 0.6 part of CH 300=mixed aryl/alkyl phosphite from Crompton was added to the mixture (cf. Table 2). Low YI values indicate good stabilization.

TABLE 2

| | Example | | | | | | | |
|---|---|---|---|---|---|---|---|---|
| | 1* | 2 | 3 | 4 | 5 | 6 | 7 | 8 |
| Stabilizer according to | — | — | — | 1 | 1 | 2 | 2 | 3 |
| Table 1 | | | | | | | | |
| Parts | — | — | — | 1.2 | 1.2 | 1.2 | 1.2 | 0.3 |
| Parts of CH 300 | — | — | 0.6 | — | 0.6 | — | 0.6 | — |
| Min | YI value | | | | | | | |
| 0 | 18.86 | 19.68 | 18.15 | 13.82 | 10.65 | 11.51 | 7.55 | 12.44 |
| 3 | 16.47 | 30.48 | 29.36 | 19.5 | 15.4 | 16.42 | 10.12 | 15.06 |
| 6 | 33.61 | 46.05 | 53.24 | 24.19 | 21.61 | 22.78 | 14.97 | 20.01 |
| 9 | 53.43 | 69.51 | 83.07 | 34.29 | 31.98 | 27.4 | 21.65 | 26.87 |
| 12 | 76.46 | 96.14 | 114.45 | 49.03 | 48.71 | 52.4 | 30.95 | 44.8 |
| 15 | 105.31 | 133.21 | | 70.39 | 65.92 | 63.41 | 46.22 | 64.14 |
| 18 | | | | 97.39 | 76.27 | 83.83 | 67.92 | 93.53 |
| 21 | | | | 118.27 | 93.73 | 109.44 | 95.12 | 125.24 |
| 24 | | | | | 111.99 | | 133.49 | |
| 27 | | | | | | | | |

| | Example | | | | | | |
|---|---|---|---|---|---|---|---|
| | 9 | 10 | 11 | 12 | 13 | 14 | 15 |
| Stabilizer according to | 3 | 4 | 4 | 5 | 5 | 6 | 6 |
| Table 1 | | | | | | | |
| Parts | 0.3 | 0.6 | 0.6 | 0.6 | 0.6 | 0.3 | 0.3 |
| Parts of CH 300 | 0.6 | — | 0.6 | — | 0.6 | — | 0.6 |
| Min | YI value | | | | | | |
| 0 | 10.01 | 17.22 | 15.68 | 17.32 | 14.51 | 15.09 | 12.66 |
| 3 | 11.27 | 17.62 | 17.85 | 22.51 | 16.77 | 21.14 | 20.61 |
| 6 | 14.29 | 26.41 | 26.71 | 38.35 | 25.03 | 28.61 | 28.34 |
| 9 | 18.89 | 39.5 | 43.25 | 46.88 | 41.94 | 45.65 | 26.97 |
| 12 | 28.41 | 52.96 | 66.24 | 48.23 | 57.97 | 65.39 | 39.41 |
| 15 | 51.6 | 69.54 | 92.61 | 60.06 | 68.11 | 84.69 | 50.49 |
| 18 | 67.95 | 87.95 | 98.24 | 77.31 | 64.91 | 108.96 | 66.41 |
| 21 | 95.94 | 105.32 | 99.63 | 109.95 | 80.17 | | 87.72 |
| 24 | 123.25 | | 110.55 | | 113.52 | | 101.22 |
| 27 | | | | | | | |

*does not comprise TEA

### EXAMPLE 2

### Static Heat Test

A mixture composed of
100.0 parts of Evipol (trademark of EVC) SH 7020-PVC K value 70
47.0 parts of dioctyl phthalate
3.0 parts of ESO=epoxidized soya bean oil
0.3 part of Loxiol® G 71 S=pentaerythritol adipate complex ester-lubricant
0.1 part of calcium stearate
x parts of a stabilizer given in Table 1

and 0.3 part of triethanolamine (TEA) was rolled for 5 minutes at 180° C. on mixing rolls. Test film strips of thickness 0.5 mm were taken from the resultant milled sheet. The film specimens were subjected to heat in an oven (=Mathis-Thermo-Takter) at 190° C. At 3 minute intervals the Yellowness Index (YI) was determined to ASTM D1925-70. The results are seen in Table 2. Where appropriate, 0.6 part of CH 300=mixed aryl/alkyl phosphite from Crompton was added to the mixture (cf. Table 3). Low YI values indicate good stabilization.

TABLE 3

Example

| | 16 | 17* | 18 | 19 |
|---|---|---|---|---|
| Stabilizer according | — | 3 | 3 | 3 |
| to Table 1 | | | | |
| Parts | — | 0.15 | 0.15 | 0.15 |
| Parts of CH 300 | — | 0.6 | — | 0.6 |
| | YI value | | | |
| 0 | 18.81 | 22.77 | 13.33 | 10.62 |
| 3 | 22.51 | 24.91 | 14.53 | 10.5 |
| 6 | 32.57 | 29.29 | 22.53 | 12.39 |
| 9 | 47.33 | 36.67 | 31.69 | 15.97 |
| 12 | 68.18 | 51.94 | 48.96 | 24.38 |
| 15 | 99.19 | 70.81 | 77.07 | 49.93 |
| 18 | 124.85 | 85.81 | 109.68 | 84.83 |
| 21 | | 99.95 | | 117.19 |
| 24 | | 114.17 | | |
| 27 | | | | |

*does not comprise TEA

### EXAMPLE 3

### Pressed PVC Sheet

A mixture composed of
100.00 parts of Evipol (trademark of EVC) SH 7020=PVC with K value 70
47.0 parts of dioctyl phthalate
3.0 parts of ESO=epoxidized soya bean oil
0.3 part of Loxiol® G 71 S-pentaerythritol part adipate complex ester-lubricant
0.1 part of calcium stearate
0.3 part parts of triethanolamine (TEA)
x parts of a stabilizer given in Table 1
   was rolled at 180° C. for 5 minutes on mixing rolls. A pressed sheet was produced from the resultant milled sheet in a preheated multisheet press. Pressed sheet thickness 2 mm, pressing time 2 minutes.

The Yellowness Index (YI) of this pressed sheet was determined to ASTM D1925-70 and the transparency was measured in % to ASTM D2805-80. The results are seen in Table 4. Low YI values mean good stabilization or initial colour. High percentages mean good transparecy.

TABLE 4

Example

| | 20 | 21* | 22 | 23 |
|---|---|---|---|---|
| Stabilizer (I) | — | 3 | 3 | 3 |
| according to Table 1 | | | | |
| Parts | — | 0.15 | 0.15 | 0.15 |
| Parts of CH 300 | — | 0.6 | — | 0.6 |
| YI value | 88.3 | 70.6 | 50.3 | 29.7 |
| Transparency | 83.1 | 92.4 | 94.3 | 96.3 |

*does not comprise TEA

The use of sulphate ester salt/sulphonate salt (formula I) combined with triethanolamine (formula II) is seen to give good stabilization. Stability can be further increased via combination with phosphite (CH 300).

1. A stabilizer mixture for stabilizing chlorine-containing polymers against thermal induced degradation, comprising
a) at least one sulphate ester salt and/or sulphonate salt of the formula (I)
[R(O)ₛSO₃]ₜM (I) and
b) and at least one alkanolamine of the formula (II) 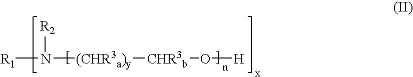
wherein M is an alkali metal cation, alkaline earth metal cation, lanthanoid (cerium) cation or aluminum cation, t is the valency of the metal cation; s is 0 or 1 and R is C₁-C₂₂alkyl, phenyl, C₇-C₁₀phenylalkyl, or C₇C₂₄-alkylphenyl and
x is 1, 2 or 3,
y is 1, 2, 3, 4, 5 or 6,
n is 1-10
R¹ and R² are independently H, C₁-C₂₂ alkyl, —[—(CHR³ₐ)_{y}—CHR³_{b}—O—]ₙ—H, —[—(CHR³ₐ)_{y}—CHR³_{b}—O-]n-CO—R⁴, C₂-C₂₀alkenyl, C₂-C₁₈acyl, C₄-C₈cycloalkyl, which may be OH-substituted in the β position, C₆-C₁₀aryl, C₇-C₁₀alkaryl or C₇-C₁₀aralkyl, or when x=1, R¹ and R² together with the N atom to which they are bonded are Joined together to form a closed 4-10 membered heterocyclic ring of carbon atoms and optionally containing up to 2 heteroatoms, or when x=2, R¹ may be a C₂-C₁₈ alkylene which may be OH-substituted at both β-carbon atoms and/or may be interrupted by one or more O-atoms and/or one or more NR₂ groups, or a dihydroxy-substituted tetrahydrodicyclopentadienylene, dihydroxy-substituted ethylcyclohexanylene, dihydroxy-substituted 4,4′-(bisphenol A dipropyl ether)ylene, isophoronylene, dimethyl-cyclohexanylene, dicyclohexylmethanylene, or 3,3′-dimethyldicyclohexylmethanylene, and if x=3, R¹ may be a trihydroxy-substituted (tri-N-propyl isocyanurate)triyl; R³ₐ, and R³_{b} independently are a C₁-C₂₂alkyl, C₂-C₆alkenyl, C₆-C₁₀ aryl, H or CH₂—X—R⁵, where X is O, S, —O—CO— or —CO—O—; R⁴ is a C₁-C₁₈-alkyl/alkenyl or phenyl, and R⁵ is H, C₁-C₂₂alkyl, C₂-C₂₂alkenyl or C₆-C₁₀aryl.

2. (canceled)

3. The stabilizer mixture according to claim 1, where in the compound of formula II R³ₐ and R³_{b} are, independently of one another, H or CH₃ and y is 1.

4. The stabilizer mixture according to claim 1, where in the compound having formula II R¹═R²═CH₂—CHR³_{b}—OH.

5. The stabilizer mixture according to claim 1, where the compounds of the general formula II are selected from the group consisting of tris(2-hydroxy-1-propyl)amine, tris(2-hydroxy-ethyl)amine, bis(2-hydroxyethyl)(2-hydroxy-1-propyl)amine or alkyl/alkenylbis(2-hydroxyethyl)-amine, N-oleylbis(2-hydroxyethyl)amine, N-soyabis(2-hydroxyethyl)amine, alkyl/alkenyl(2-hydroxy-1-propyl)amine, N-(2-hydroxyhexadecyl)-diethanolamine, N-(2-hydroxy-3-octyloxypropyl)-diethanolamine, N-(2-hydroxy-3-decyloxypropyl)-diethanolamine and mixtures thereof.

6. The stabilizer mixture according to claim 1, wherein in the sulphate ester salt and/or sulphonate salt M is Li, Na, K, Mg, Ca, Sr, Ba, Zn, Al, La, Ce or a hydrotalcite layer-lattice cation; t is 1, 2 or 3, and in the case of a hydrotalcite layer-lattice cation, 0<t≦1.

7. The stabilizer mixture according to claim 1, wherein in the sulphate ester salt and/or sulphonate salt, M is Na or K and t is 1.

8. The stabilizer mixtures according to claim 1, further comprising an aminouracil, enamine, indole or urea.

9. The stabilizer mixture according to claim 1, further comprising an anhydrous hydrotalcite or a zeolite.

10. The stabilizer mixture according to claim 1, further comprising metal soaps, polyols, disaccharide alcohols, glycidyl compounds, hydrotalcites, alkali metal/alkaline earth metal aluminosilicates, alkali metal/alkaline earth metal hydroxide/oxides, or alkali metal/alkaline earth metal (hydrogen) carbonates, or carboxylates, fillers/pigments, plasticizers, antioxidants, light stabilizers, optical brighteners, lubricants, epoxidized fatty esters and mixtures thereof.

11. The stabilizer mixture according to claim 1, further comprising a phosphite or a reaction product of a phosphite with component (a) and/or (b).

12. The stabilizer mixture according to claim 1, wherein the phosphite is selected from the group consisting of distearyl pentaerythritol diphosphite, triphenyl phosphite, trisnonylphenyl phosphite, phenyl didecyl phosphite, polydipropylene glycol phenyl phosphite, tetraphenyl dipropylene glycol diphosphite, tetraisodecyl dipropylene glycol diphosphite, tris (dipropylene glycol) phosphite, decyl diphenyl phosphite, trioctyl phosphite, trilauryl phosphite (nonylphenyl_{1.5} C₁₂/C₁₃-alkyl)_{1.5} phosphite and mixtures thereof.

13. A composition comprising a chlorine-containing polymer and the stabilizer mixture according to claim 1.

14. The composition according to claim 13, comprising from 0.01 to 10 parts by weight of the compound of the general formula (II) and from 0.001 to 10 parts by weight of the general formula (I) and, optionally, from 0.05 to 5 parts by weight of a phosphate, based on 100 parts by weight of the chlorine-containing polymer.

15. A process for stabilizing chlorine-containing polymers against thermal induced degradation by adding the stabilizer mixture according to claim 1 to a chlorine-containing polymer.

16. The process for stabilizing chlorine-containing polymers against thermal induced degradation according to claim 15, wherein the chlorine-containing polymer is plasticized polyvinyl chloride.

17. The process for stabilizing chlorine-containing polymers against thermal induced degradation according to claim 15, wherein the chlorine-containing polymer comprises flooring, motor vehicle parts, plasticized films, tubing, injection molding, wire sheathing, or plastisols.

18. The process for stabilizing chlorine-containing polymers against thermal induced degradation according to claim 15, wherein the chlorine-containing polymer is unplasticized polyvinyl chloride.

19. (canceled)

20. A consumer article comprising a polyvinyl chloride stabilized against thermal induced degradation by the stabilizer mixture according to claim 1.

21. (canceled)

22. (canceled)

23. The composition according to claim 13, wherein the chlorine-containing polymer is selected from the group consisting of a polymer of vinyl chloride, polymer of vinylidene chloride, polymer of a vinyl resin containing vinyl chloride units, copolymer of vinyl chloride with a diene compound and an unsaturated carboxylic acid or anhydride thereof post chlorinated polymer or copolymer of vinyl chloride, copolymer of vinyl chloride and vinylidene chloride with an unsaturated aldehyde or ketone, polymer of vinyl chloroacetate and a dichlorodivinyl ether, chlorinated polymer of vinyl acetate, chlorinated polymeric ester of acrylic acid and an alpha-substituted acrylic acid, polymer of a chlorinated styrene, chlorinated rubber, chlorinated polymer of ethylene, polymer or post-chlorinated polymer of chlorobutadiene or a copolymer thereof with vinyl chloride or a chlorinated natural or synthetic rubber and mixtures thereof.

24. The process according to claim 15, wherein the chlorine-containing polymer is selected from the group consisting of a polymer of vinyl chloride, polymer of vinylidene chloride, polymer of a vinyl resin containing vinyl chloride units, copolymer of vinyl chloride with a diene compound and an unsaturated carboxylic acid or anhydride thereof, post chlorinated polymer or copolymer of vinyl chloride, copolymer of vinyl chloride and vinylidene chloride with an unsaturated aldehyde or ketone, polymer of vinyl chloroacetate and a dichlorodivinyl ether, chlorinated polymer of vinyl acetate, chlorinated polymeric ester of acrylic acid and an alpha-substituted acrylic acid, polymer of a chlorinated styrene, chlorinated rubber, chlorinated polymer of ethylene, polymer or post-chlorinated polymer of chlorobutadiene or a copolymer thereof with vinyl chloride or a chlorinated natural or synthetic rubber and mixtures thereof.
